(19) United States
(12) Patent Application Publication
(10) Pub. No.: US 2003/0019689 A1
(43) Pub. Date: Jan. 30, 2003

(54) Electric lifting apparatus for use with a ladder

(76) Inventor: Dannie l. Dorsett, Bakersfield, CA (US)

Correspondence Address: James M. Duncan, Klein, DeNatale, Goldner, etc., P.O. Box 11172, Bakersfield, CA, 93389-1172, US

(21) Appl. No.: 10/251,319

(22) Filed: Sep. 19, 2002

Related U.S. Application Data
(63) Continuation-in-part of application No. 09/653,576, filed on Aug. 31, 2000, now Pat. No. 6,454,049.

(51) Int. Cl. E06C 7/16

(52) U.S. Cl. 182/129; 182/121

(57) ABSTRACT

A portable lifting apparatus is disclosed wherein the apparatus is adapted to be used in combination with a runged-ladder. The apparatus comprises a rigid frame having a rearward end and a forward end. The rearward end is engaged to a first rung of the ladder. The forward end is retained by the user. A foldable brace connects to a second rung of the ladder to provide additional support. The apparatus is manually positioned by a user standing on a roof or elevated structure. Maintaining the device in a generally horizontal orientation, the user activates an electrically driven winch raising or lowering a load. A brace is pivotally attached to the frame, the brace having a pivoting end and a locking end. The locking end is adapted to engage a second rung of the ladder. The brace may be folded against the rigid frame.

### CROSS REFERENCE TO RELATED APPLICATION

This is a continuation-in-part of U.S. application Ser. No. 09/653,576 filed on Aug. 31, 2000, to which the inventor claims domestic priority, and which is incorporated by reference herein.

### BACKGROUND OF THE INVENTION

This invention relates generally to lifting devices for use on a temporary basis to lift heavy items up to, or to lower them down from, an elevated height, such as the roof of a building or top of a platform. More specifically, the present device relates to a hoist and frame which attaches to a ladder to allow a single individual to raise and lower heavy objects.

There are many instances in which a relatively heavy load must be raised from the ground to an elevated height, such as the roof of a building. For example, an air conditioning repair man may need to raise a new or repaired compressor to the top of a building, and afterwards lower the old unit to the ground. Because an air conditioning compressor may weigh from 50 to 150 pounds, carrying the devices up a ladder is difficult and hazardous. However, other alternatives, such as cranes and forklifts, are not always readily available, require additional personnel, and increase the expense of the operation. Other applications for the device are readily apparent, such as when roofing materials must be raised to the top of a building.

### SUMMARY OF THE INVENTION

The present invention is a portable lifting apparatus adapted to be used in combination with a runged-ladder and manually positioned by a user at an elevated position above ground level for the purpose of selectively moving a given load between a low position and an elevated position. The portable lifting apparatus comprises a rigid frame adapted to be manually placed with a generally horizontal orientation at an elevated location with respect to the ground, and the frame having a forward end and a rearward end. The rearward end is adapted to engage a first rung of the ladder. The invention further comprises an electrically powered winch that is rigidly connected to the rigid frame, the winch having a rotatable drum and a cable with proximate and distal ends. The proximate end of the cable is connected to the drum and rotates with the drum. The distal end of the cable is configured for selective connection to the given load for supporting, raising or lowering the load. A source of electrical power is connected to the winch and a manually actuated switch that is wired to control actuation of the winch. A brace is pivotally attached to the frame, the brace having a pivoting end and a locking end. The locking end is adapted to engage a second rung of the ladder.

### BRIEF DESCRIPTION OF THE DRAWINGS

FIG. 1 schematically shows a user preparing to carry the disclosed lifting apparatus to the top of a structure.

FIG. 2 schematically shows a user preparing to raise a load to the top of a structure.

FIG. 3 schematically shows a load raised to the apparatus.

FIG. 4 schematically shows how the load is delivered to the top of the structure.

FIG. 5 is a perspective view of the disclosed lifting apparatus, with the brace extended downwardly.

FIG. 6 is a side elevation view of the disclosed lifting apparatus, showing the apparatus engaging two rungs of a ladder.

FIG. 7 is a side elevation view of the disclosed lifting apparatus.

FIG. 8 is a top view of the disclosed lifting apparatus, with the brace in the stored position parallel to and secured to the rigid frame.

FIG. 9 is a perspective view of the disclosed lifting apparatus, where the brace is in the stored position, parallel to and secured to the rigid frame.

FIG. 10 is a detailed view of the rearward end of the rigid frame.

FIG. 11 is a bottom view of the disclosed lifting apparatus.

### DETAILED DESCRIPTION OF THE EMBODIMENTS

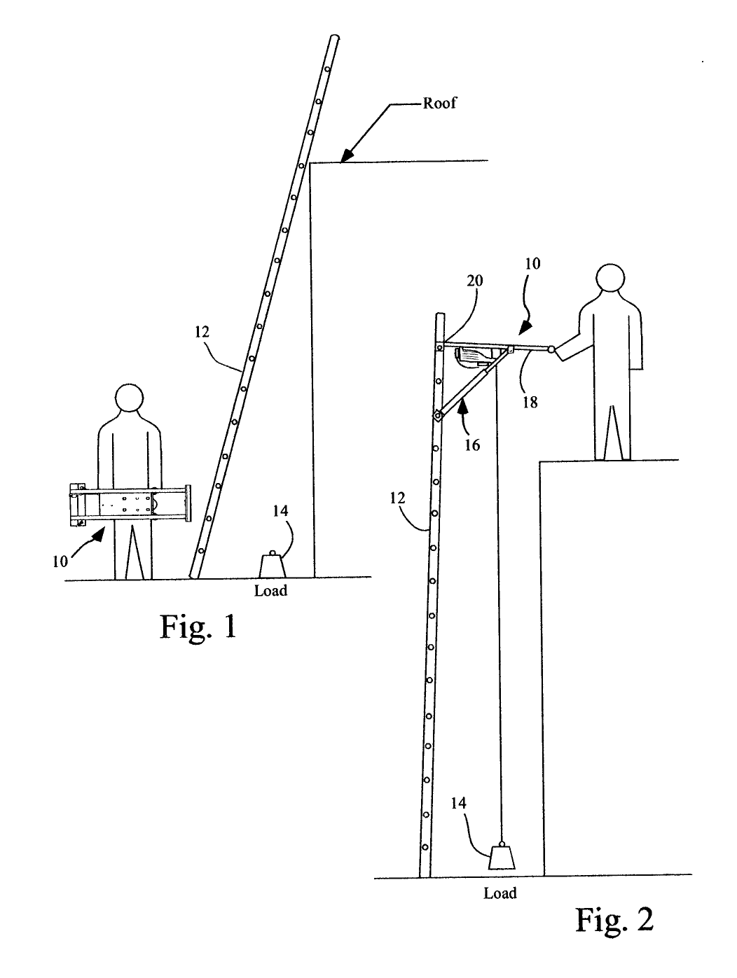

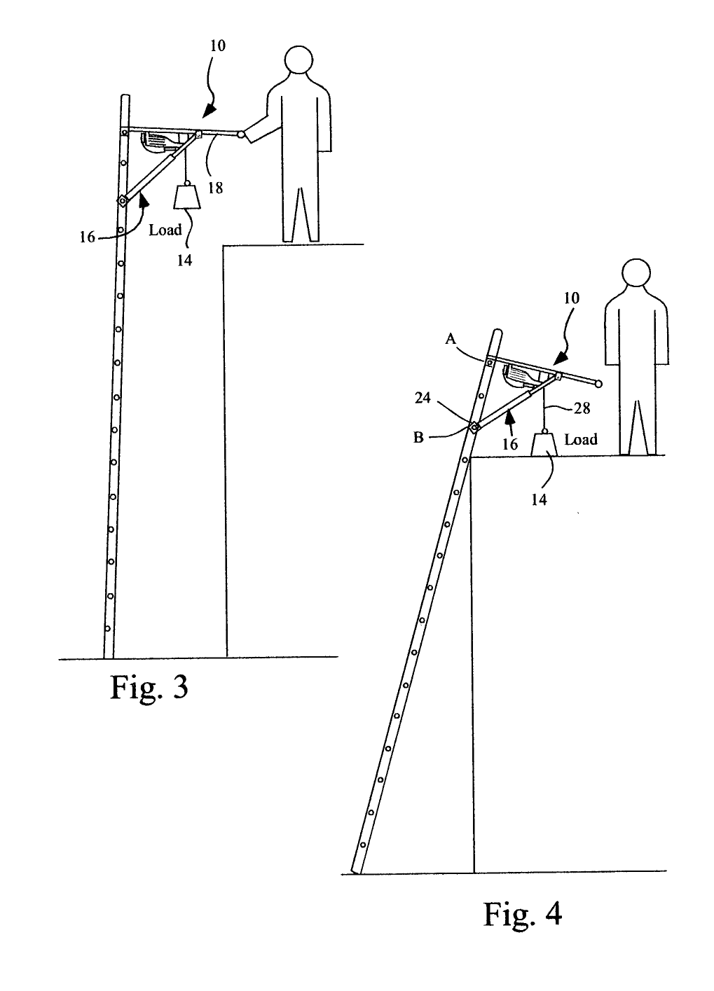

Referring now specifically to the drawings, FIGS. 1 through 4 show, schematically, how a single user may use the disclosed apparatus to convey heavy objects to the top of a building or other structure. The apparatus 10 is carried up ladder 12 by the user, with the device in a folded position, i.e., with the brace 16 secured to the rigid frame 18, leaving load 14 on the ground. When the brace 16 is folded and parallel to the rigid frame 18, the lifting apparatus 10 can be carried up a ladder by a worker, who then connects the device to the ladder after reaching a desired location on the roof or platform. The weight of the lifting apparatus 10 may be reduced by manufacturing the structural components from aluminum tubing, to make it easier for the user to carry the apparatus 10 up the ladder 12. Alternatively, the user may attach a rope to the apparatus 10 to lift it to the roof or platform.

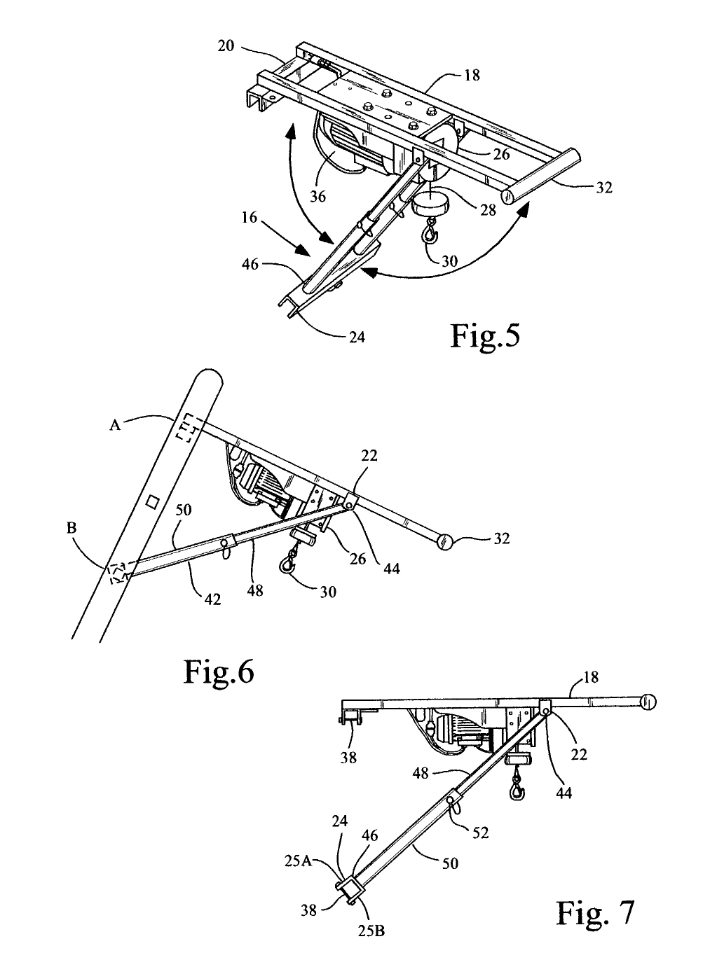

When the lifting apparatus 10 has been carried to the roof, the brace 16 is unfolded from the rigid frame 18. The rearward end 20 of the rigid frame 18 and the locking end 24 of the brace 16 are attached to rungs on an upper part of the ladder 12. As shown in FIG. 2, the apparatus 10 is secured to the ladder 12 at two different rungs of the ladder. The side of the rigid frame 18 opposite the user, defined herein as the rearward end 20, is adapted to engage a first rung A of the ladder 12. Brace 16 is pivotally attached to the frame 18 with pivoting means 22, such as pins or bolts inserted through lugs attached to the rigid frame 18, or sleeved openings in the rigid frame. Being pivotally attached to the frame 18, the brace 16 may be rotated from a folded or stored position parallel to and abutting the rigid frame 18, to a plurality of positions where the brace 16 extends downwardly from the frame, the brace and frame forming an angle with respect to one another. Locking end 24 is adapted to engage a second rung B of the ladder 12 which is beneath the first rung A engaged by the rearward end 20 of the frame 18. It is to be appreciated that the terms “first rung” and “second rung” do not refer to specific rungs on a ladder, but are used to distinguish between the rung engaged by the rearward end 20 of the frame 18 and the rung engaged by locking end 24 of the brace 16. As shown in FIG. 6, for most ladders, the first rung A engaged by the rearward end 20 and the second rung B engaged by locking end 24 will be separated by an intermediate rung.

The forward end 32 of the apparatus 10 is supported by the user, such that the rigid frame is maintained in a generally horizontal orientation. The cable 28 is played out until a sufficient length to reach the ground has been released. A hook 30 at the distal end of the cable 28 is then connected to load 14 on the ground. Mounted on the rigid frame 18 is an electrically powered winch 26 which is selectively actuated to raise or lower the cable 28, hook 30 and any load to which the cable and hook are attached. The winch 26 has a rotatable drum 27 to which the cable 28 is wound, with the cable's proximate end secured to the drum, so that the cable is either taken up or release as the drum 27 rotates. Actuation of the winch is preferably accomplished with a rocker-type switch 31 that is located at the forward end 32 of the rigid frame 18. Forward end 32 may be fashioned from round stock to provide a convenient carrying handle for the user. The switch 31 may be a double pole, normally OFF, momentarily ON switch, so that the winch's motor 36 is actuated for only as long as the switch is depressed, whether a load is being raised or lowered.

A source of electrical power, usually 110 volt AC power, is attached to plug 34 to provide power for motor 36, which is coupled to the winch 26. Plug 34 is a UL approved 3-prong grounded connector with a double insulated power cord lead from the motor 36. One acceptable motor is a 100 volt ¾ horsepower motor. The winch 26 may be the same or comparable to a Model No. SA5000AC winch made and sold by Dutton-Lainson Company of Hastings, Nebr. The cable 28 may be braided steel wire cable having a nominal diameter of about ⅛ inch, which has been found to be suitable for lifting all of the loads for which this apparatus is likely to be used. The winch may further comprise automatic winding guides to prevent cable overlap.

The disclosed apparatus 10 may be configured to have a 220 pound lifting capacity with a line speed of 33 feet per minute. The rotatable drum 27 may contain 38 feet of ⅛ inch cable 28. The motor may be equipped with an auto stop feature so that the motor 36 stops running when the hook 30 reaches the winch 26.

It is to be appreciated that brace 16 may be fabricated to either have a single support member, or to have multiple support members as depicted in the figures herein. Brace 16 may be comprised of a pair of parallel support arms 42 which are attached to locking end 24. Each support arm 42 has a pivoting end 44 and an opposite end 46. The pivoting end 44 is pivotally attached to the rigid frame 18 with pivoting means 22. Each opposite end 46 is connected to the locking end 24, the locking end perpendicular to the support arms 42. Each support arm 42 may comprise an inner tube 48 slideably inserted within an outer tube 50, so that the support arms 42 are capable of telescoping, i.e., having variable length. The inner tube 48 may have a first plurality of holes and the outer tube 50 may have a second plurality of holes, where the first plurality of holes is selectively alignable with the second plurality of holes, so that the support arms 42 may be locked at a specific length by inserting a locking pin 52 through a hole in outer tube 50 which is aligned with a hole in inner tube 48. The telescoping feature of the support arms 42, and hence of the brace 16, allows the user to adjust the length of brace 16 as necessary to engage a rung of the ladder 12 with the brace.

While different shapes may be used for rearward end 20 and locking end 24 for engaging rungs of the ladder 12, rearward end 20 may comprise a first U-shaped bracket for engaging a rung of the ladder 12. The first U-shaped bracket may comprise a pair of spaced apart facing members 21A and 21B, each member having a hole aligned and facing a hole in the corresponding member. Similarly, locking end 24 may also comprise a second U-shaped bracket for engaging a rung of the ladder 12 for engaging a rung of the ladder 12. The second U-shaped bracket may comprise a pair of spaced apart facing members 25A and 25B, each member having a hole aligned and facing a hole in the corresponding member. Retaining pins 38 may be inserted through two aligned holes in the U-shaped rearward end 20 and locking end 24 to hold the frame 18 to the ladder 12, thereby comprising locking means for respectively securing the rearward end 20 to the first rung A and for securing the locking end 24 to the second rung B.

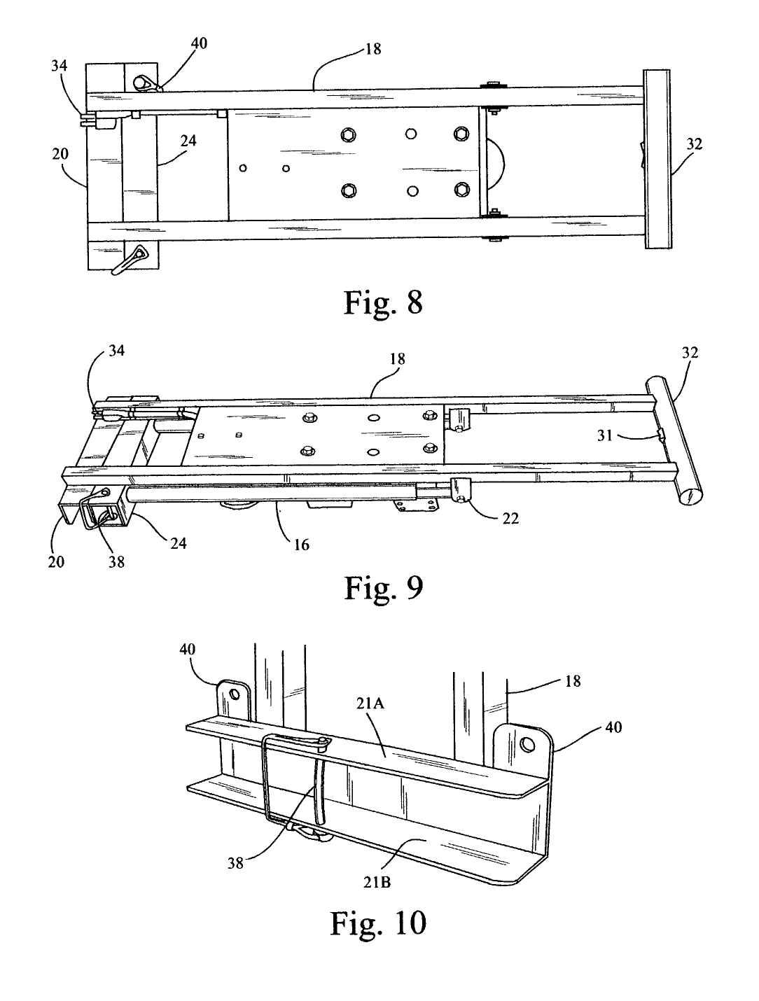

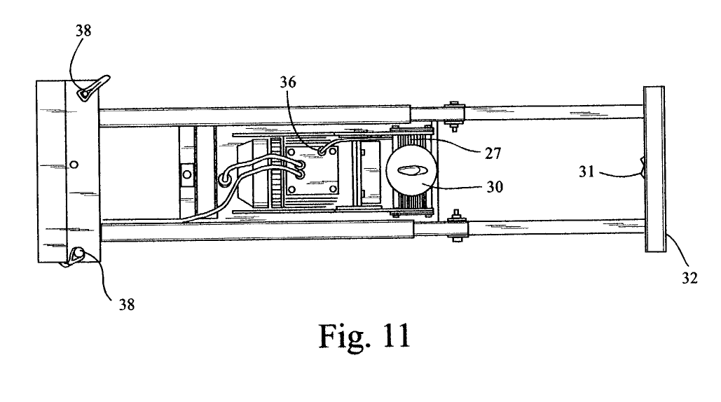

As shown in FIGS. 8 and 9, brace 16 may be retained in its stored position by retaining pin 38, which is inserted through holes in locking end 24 and secured to retaining tabs 40, which may be attached to rigid frame 18. Retaining tabs 40 have holes which are of sufficient diameter to receive retaining pin 38. The brace 16 may be made to lie in the same general plane as the frame during transportation and storage, and held in place with retaining pin 38. When the user desires to attach the apparatus to a ladder, retaining pins 38 are simply pulled, allowing brace 16 to pivot freely on pivoting means 22.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed.

What is claimed is:

1. A portable lifting apparatus adapted to be used in combination with a runged-ladder and manually positioned by a user at an elevated position above ground level for the purpose of selectively moving a given load between a low position and an elevated position, comprising:
(a) a rigid frame adapted to be manually placed with a generally horizontal orientation at an elevated location with respect to the ground, and the frame having a forward end and a rearward end, the rearward end adapted to engage a first rung of the ladder;
(b) an electrically powered winch that is rigidly connected to the rigid frame, said winch having a rotatable drum and a cable with proximate and distal ends, the cable's proximate end being connected to the drum for rotation therewith, and the distal end of the cable being configured for selective connection to the given load for supporting the same;
(c) a source of electrical power connected to the winch;
(d) a manually actuated switch that is wired to control actuation of the winch; and
(e) a brace having a pivoting end and a locking end, the pivoting end pivotally attached to the frame, and the locking end adapted to engage a second rung of the ladder.

2. The portable lifting apparatus of claim 1 wherein the brace has a stored position where the brace is generally parallel to the frame.

3. The portable lifting apparatus of claim 2, further comprising means for locking the brace in the stored position.

4. The portable lifting apparatus of claim 1 further comprising locking means for securing the rearward end to the first rung and for securing the locking end to the second rung of the ladder.

5. The portable lifting apparatus of claim 1 wherein the manually actuated switch is enclosed within the forward end of the frame.

6. The portable lifting apparatus of claim 1 wherein the rearward end is U-shaped.

7. The portable lifting apparatus of claim 1 wherein the locking end is U-shaped.

8. A portable lifting apparatus adapted to be used in combination with a runged-ladder and manually positioned by a user at an elevated position above ground level for the purpose of selectively moving a given load between a low position and an elevated position, comprising:
(a) a rigid frame adapted to be manually placed with a generally horizontal orientation at an elevated location with respect to the ground, and the frame having a forward end and a rearward end, the rearward end adapted to engage a first rung of the ladder;
(b) an electrically powered winch that is rigidly connected to the rigid frame, said winch having a rotatable drum and a cable with proximate and distal ends, the cable's proximate end being connected to the drum for rotation therewith, and the distal end of the cable being configured for selective connection to the given load for supporting the same;
(c) a source of electrical power connected to the winch;
(d) a manually actuated switch that is wired to control actuation of the winch; and
(e) a brace comprising a pair of parallel support arms attached to a locking end, each support arm having a pivoting end and an opposite end, the pivoting end pivotally attached to the frame, and each opposite end connected to the locking end, the locking end perpendicular to the support arms.

9. The portable lifting apparatus of claim 8 wherein the brace has a stored position where the brace is generally parallel to the frame.

10. The portable lifting apparatus of claim 9, further comprising means for locking the brace in the stored position.

11. The portable lifting apparatus of claim 8 wherein the manually actuated switch is enclosed within the forward end of the frame.

12. The portable lifting apparatus of claim 8 further comprising locking means for securing the rearward end to the first rung and for securing the locking end to the second rung of the ladder.

13. The portable lifting apparatus of claim 9, wherein each support arm comprises an inner tube slideably inserted within an outer tube.

14. The portable lifting apparatus of claim 13, wherein the inner tube has a first plurality of holes and the outer tube has a second plurality of holes selectively alignable with the first plurality of holes.

15. The portable lifting apparatus of claim 14, the support arm further comprising pin means for inserting into the outer tube and inner tube to lock the length of each support arm.

16. The portable lifting apparatus of claim 8 wherein the rearward end comprises a first U-shaped bracket having a pair of spaced apart facing members, each member having a hole facing and aligned and with a hole in the corresponding member.

17. The portable lifting apparatus of claim 10 wherein the locking end comprises a second U-shaped bracket having a pair of spaced apart facing members, each member having a hole aligned and facing a hole in the corresponding member.

18. The portable lifting apparatus of claim 17 wherein the means for locking the brace in the stored position comprises locking tabs attached to the rigid frame, the locking tabs having holes which align with the holes in the second U-shaped bracket when the brace is in the stored position.
